(19) United States
(12) Patent Application Publication
(10) Pub. No.: US 2011/0002766 A1
(43) Pub. Date: Jan. 6, 2011

(54) MECHANICAL ARM FOR DISPENSING MEDICINES

(76) Inventor: Chi-Kuang Chen, Taipei City (TW)

Correspondence Address: Muncy, Geissler, Olds & Lowe, PLLC, 4000 Legato Road, Suite 310, FAIRFAX, VA, 22033, US

(21) Appl. No.: 12/496,288

(22) Filed: Jul. 1, 2009

(51) Int. Cl. B66C 3/00

(52) U.S. Cl. 414/732

(57) ABSTRACT

The present invention discloses a mechanical arm for dispensing medicines. The mechanical arm includes a seat, a support rod and a bracket. The support rod is extended upward from the seat, rotates freely, is retracted and fixed on the seat. The bracket is pivoted at the support rod, and an end of the bracket is provided with at least one clamp and release mechanism which rotates and is fixed on the bracket, and is used to clamp and release a default vial. By the aforementioned structures, a user can use the clamp and release mechanism to clamp the vials of various sizes, thereby achieving the practical progressiveness to clamp the vials of various sizes, which contain radiopharmaceuticals.

### BACKGROUND OF THE INVENTION

a) Field of the Invention

The present invention relates to a mechanical arm, and more particularly to a medicine dispensing mechanical arm which is capable of clamping vials of different sizes, containing radiopharmaceuticals.

b) Description of the Prior Art

In an early time, a positron computer tomography technology is mostly used to detect diseases, wherein positron-emission nuclides (radiopharmaceuticals) used by the positron computer tomography technology are produced from an accelerator, and then synthesized to many various compounds which are delivered to each infirmary. When the radiopharmaceuticals are to be delivered to each infirmary for use, the radiopharmaceuticals should be dispensed, quantified and detected with concentrations that the radiopharmaceuticals can be safely transported for use. However, as most of the radiopharmaceuticals are radioactive and therefore, if one cannot deal with radiation protection well, it will result in a great and severe impact to health of implementing personnel.

In addition, to achieve the object of radiation protection, radio-chemists, medical doctors, nurses and assistants will traditionally put a radiopharmaceutical into a vial and then emplace in a lead pot with a cap to proceed with the transportation.

However, when processing the aforementioned vial that contains the radiopharmaceutical, following issues and shortcomings actually exist to be improved.

Although using the lead pots to transport the vials that contain the radiopharmaceuticals can effectively prevent from radiation release, it is still possible to have the related personnel to be exposed in the radiation during dispensing, quantifying and detecting.

Accordingly, how to solve the aforementioned issues and shortcomings of the prior art is to be studied and researched for improvement by the present inventor and related industries

### SUMMARY OF THE INVENTION

The primary object of the present invention is to provide a mechanical arm which is able to clamp vials of different sizes, containing radiopharmaceuticals.

To achieve the aforementioned object, the present invention includes a seat, a support rod and a bracket, wherein the support rod is extended upward from the seat, and can rotate freely on the seat. Furthermore, the support rod can be retracted and fixed on the seat. The bracket is pivoted at the support rod, and an end of the bracket is provided with at least one clamp and release mechanism which can rotate and be fixed on the bracket. In addition, the clamp and release mechanism can be used to clamp and release a default vial.

As one end of the bracket of the present invention is provided with the clamp and release mechanism which can clamp and release the default vial, a user can use that clamp and release mechanism to clamp all kinds of vials of various sizes, allowing a medicine dispensing person no to contact directly with the radiopharmaceuticals. Therefore, the present invention achieves the practical progressiveness that the vials of different sizes, which contain the radiopharmaceuticals, can be clamped.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of a preferred embodiment of the present.

FIG. 3 shows a first schematic view of an implementation of a preferred embodiment of the present invention.

FIG. 4 shows a second schematic view of an implementation of a preferred embodiment of the present invention.

FIG. 5 shows a third schematic view of an implementation of a preferred embodiment of the present invention.

FIG. 6 shows a fourth schematic view of an implementation of a preferred embodiment of the present invention.

FIG. 7 shows a schematic view of an implementation of another preferred embodiment of the present invention.

### DETAILED DESCRIPTION OF THE PREFERRED EMBODIMENTS

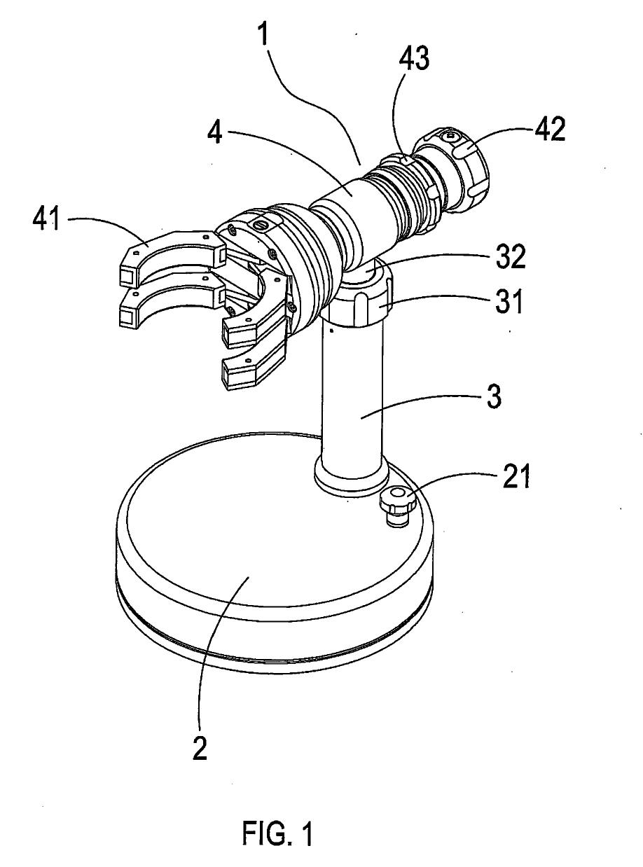

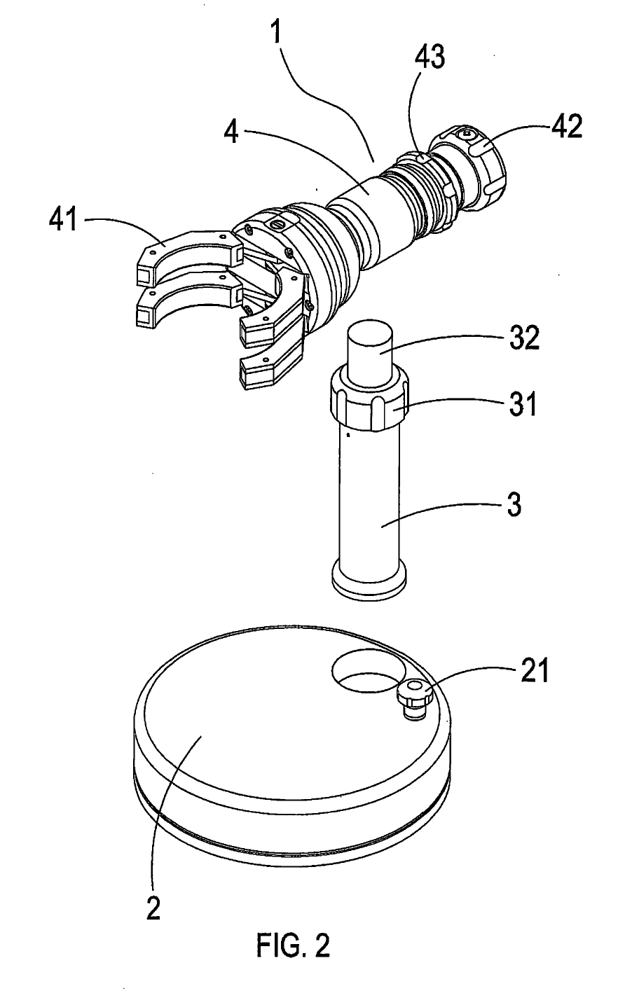

Referring to FIG. 1 and FIG. 2, it shows a three-dimensional view and an exploded view, of a preferred embodiment of the present invention, wherein a mechanical arm 1 of the present invention comprises a seat 2, which is made by a heavy material, is fixed on a desktop or ground, and is provided with a first control knob 21, a circular-shape knob as shown in the drawing, such that when turning that first control knob 21, the seat 2 is able to rotate freely and to be fixed using the first control knob 21; a support rod 3, which is extended upward from the seat 2, is extended with a strut 32, and an outer wall of which is provided with a second control knob 31, a circular collar as shown in the drawings, such that a user can rotate the second control knob 31 to extend the strut 32 out of the support rod 3, allowing the support rod 3 to be retracted, and can also use the second control knob 31 to fix the strut 32; and a bracket 4, which is pivoted at the support rod 3, an end of which is provided with a clamp and release mechanism 41, and the other end of which is provided with a third control knob 42 to control the clamp and release mechanism 41 to perform clamping and releasing, the third control knob 42 being in a circular-shape as shown in the drawings, such that the user can control the third control knob 42 to allow the clamp and release mechanism 41 to clamp or release. In addition, the bracket 4 is provided with a fourth control knob 43, in a circular collar shape as shown in the drawings, which allows the clamp and release mechanism 41 to rotate and be fixed on the bracket 4.

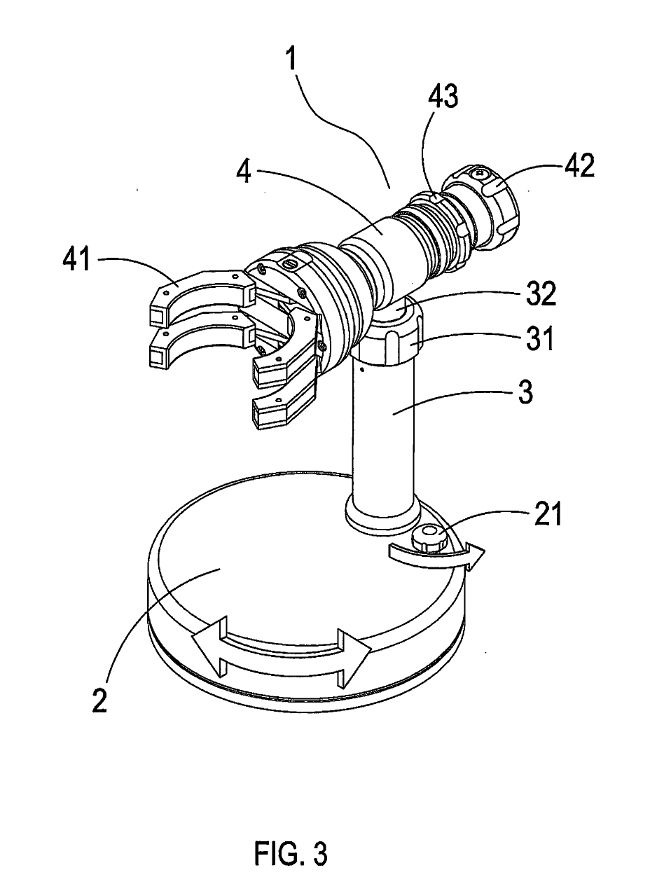

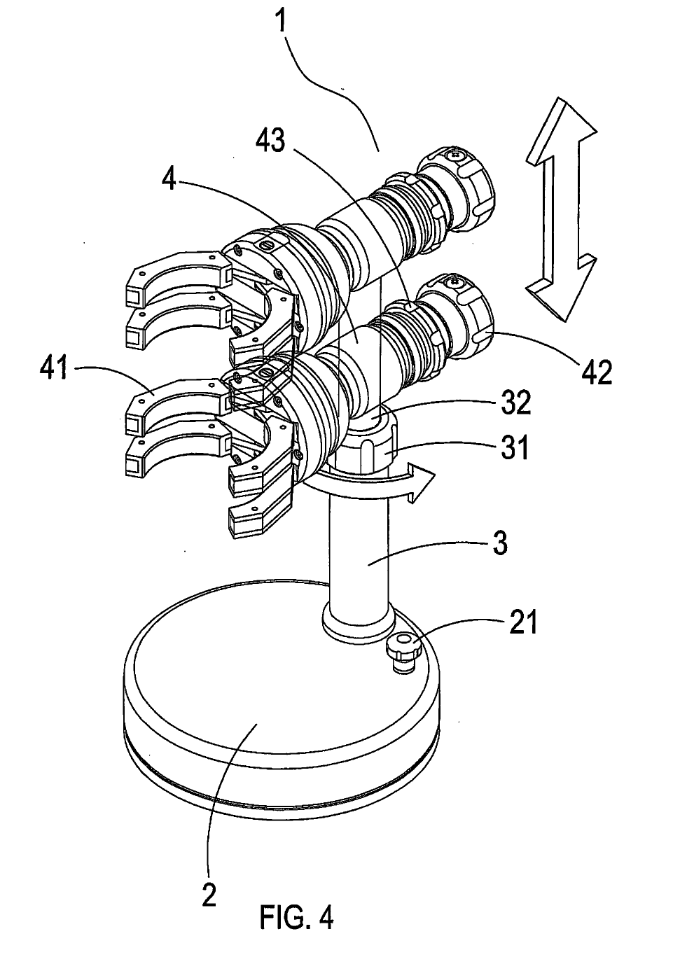

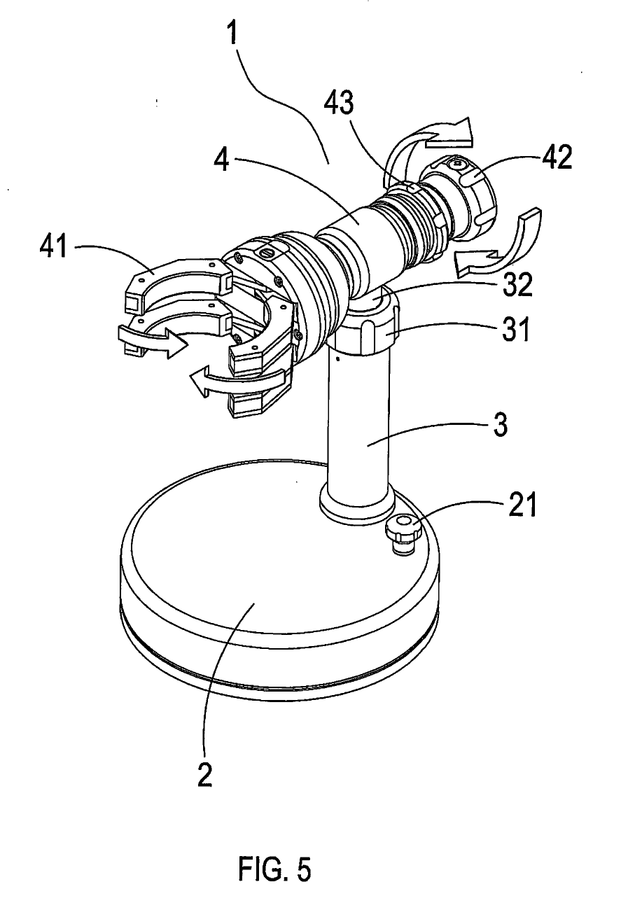

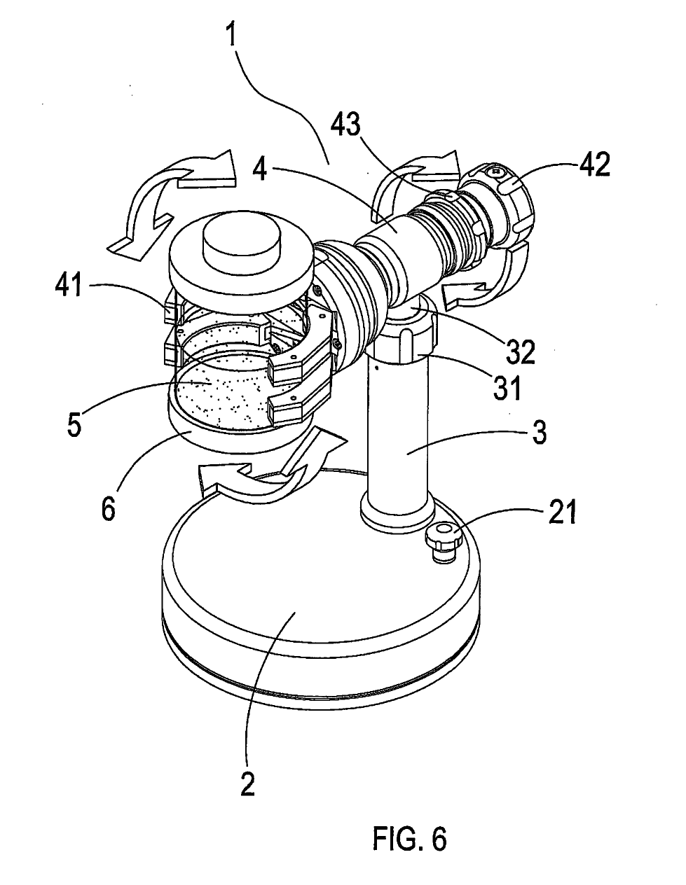

Referring to FIGS. 3 to 6, it shows a first, second, third and fourth schematic view of an implementation of a preferred embodiment of the present invention. The user can rotate the first control knob 21 that is provided on the seat 2, allowing the seat 2 to rotate freely. When a required angle is adjusted, the user can rotate the first control knob 21 tightly to fix the seat 2. As shown in FIG. 4, the user can rotate the second control knob 31 on the support rod 3, allowing the support rod 3 to be retracted on the seat 2. When a required height is adjusted, the user can rotate the second control knob 31 tightly, allowing the strut 32 to be fixed on the support rod 3. As shown in FIG. 5, the user can rotate the third control knob 42 that is located at one end of the bracket 4, allowing the clamp and release mechanism 41 to clamp or release. The user can freely adjust the third control knob 42 to control the clamp operation of the clamp and release mechanism 41. If a vial 6 is smaller, the clamp and release mechanism 41 can be controlled to clamp inward. On the contrary, when the vial 6 is larger, the clamp and release mechanism 41 can be controlled to release outward. Accordingly, the present invention can be used to clamp and fix all kinds of vials 6 of various sizes on the clamp and release mechanism 41. Referring to FIG. 6, the user can rotate the fourth control knob 43 that is located on the bracket 4, allowing the clamp and release mechanism 41 to rotate freely on the bracket 4. Thus, when clamping the vial 6, the clamp and release mechanism 41 can rotate freely, allowing a radiopharmaceutical 5 in the vial 6 to be mixed homogeneously. After the radiopharmaceutical 5 has been mixed homogeneously, the fourth control knob 43 can be rotated tightly to fix the clamp and release mechanism 41 on the bracket 4.

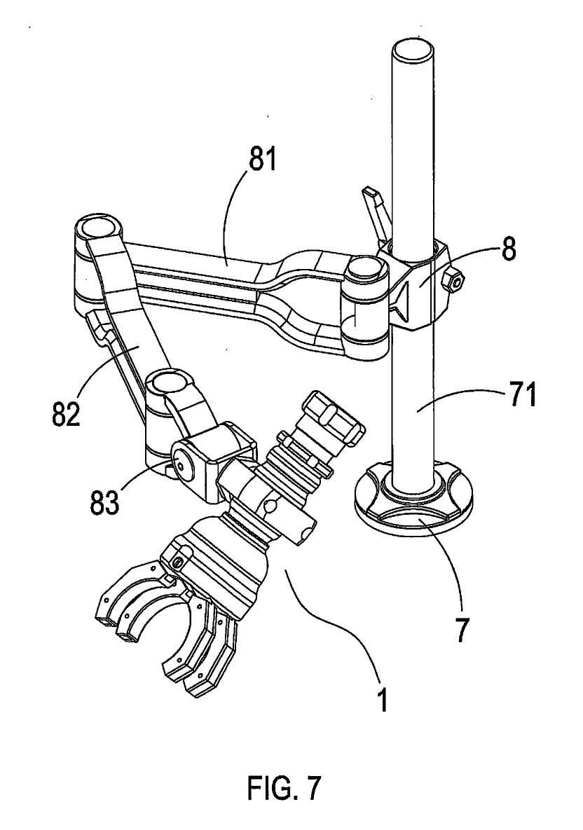

Referring to FIG. 7, it shows a schematic view of an implementation of another preferred embodiment of the present invention. As shown in the drawing, the mechanical arm 1 of the present invention comprises a base 7; a pole 71 which is extended upward from the base 7; a first pivot member 8, which ascends and descends on the pole 71 through adjustment; a first support arm 81, which is rotationally pivoted at the first pivot member 8 in a horizontal direction; a second support arm 82, which is rotationally pivoted at the first support arm 81 in a horizontal direction; and a second pivot member 83, which rotates horizontally and vertically, and supports the mechanical arm 1.

When the present invention is implemented as this another preferred embodiment, as more movable joints are provided, such as the first pivot member 8, the first support arm 81, the second support arm 82 and the second pivot member 83, an operator can be provided with better operability to comply with all kinds of various dispensing conditions.

Accordingly, referring to all the drawings, the present invention is actually provided with following advantages as compared to the prior art.

The mechanical arm 1 of the present invention includes the first control knob 21, the second control knob 31, the third control knob 42 and the fourth control knob 43. The user can freely rotate these control knobs to conduct detailed adjustment to the required angle or position. In particular, the present invention is provided with the third control knob 42 which can control the clamp and release mechanism 41 to clamp the vials 6 of various sizes. In addition, the fourth control knob 43 can be used to rotate the clamp and release mechanism 41 freely on the bracket 4. When clamping the vial 6, the clamp and release mechanism 41 can rotate freely, allowing the radiopharmaceutical 5 in the vial 6 to be mixed homogeneously. By the aforementioned structures, the practical progressiveness is achieved that the vials 6 of different sizes, which contain the radiopharmaceuticals 5, can be clamped.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A mechanical arm for dispensing medicines, which is used to dispense default radiopharmaceuticals, comprising a bracket; and at least one clamp and release mechanism which is provided at one end of the bracket, rotates and is fixed on the bracket, and is used to clamp and release a default vial.

2. The mechanical arm for dispensing medicines, according to claim 1, wherein the mechanical arm comprises a seat; and a support rod which is extended upward from the seat, rotates freely on the seat, is retracted and fixed on the seat, and supports the bracket.

3. The mechanical arm for dispensing medicines, according to claim 2, wherein the seat is provided with a first control knob which allows the seat to rotate freely and be fixed.

4. The mechanical arm for dispensing medicines, according to claim 2, wherein the support rod is provided with a second control knob which allows the support rod to be retracted and fixed on the seat.

5. The mechanical arm for dispensing medicines, according to claim 2, wherein the support rod is extended with a strut for retracting, and the bracket is pivoted on the strut.

6. The mechanical arm for dispensing medicines, according to claim 1, wherein the bracket is provided with a third control knob, at an end far away from the clamp and release mechanism, to allow the clamp and release mechanism to perform clamping and releasing.

7. The mechanical arm for dispensing medicines, according to claim 1, wherein the bracket is provided with a fourth control knob which allows the clamp and release mechanism to rotate freely and be fixed on the bracket.

8. The mechanical arm for dispensing medicines, according to claim 1, wherein the mechanical arm comprises a base; a pole which is extended upward from the base; a first pivot member, which ascends and descends on the pole through adjustment; a first support arm, which is rotationally pivoted at the first pivot member in a horizontal direction; a second support arm, which is rotationally pivoted at the first support arm in a horizontal direction; and a second pivot member, which rotates horizontally and vertically, and supports the bracket.
